(19) United States
(12) Patent Application Publication
(10) Pub. No.: US 2010/0288225 A1
(43) Pub. Date: Nov. 18, 2010

(54) Clean air reciprocating internal combustion engine

(76) Inventor: William C. Pfefferle, Madison, CT (US)

Correspondence Address: Robert L. Rispoli;Precision Combustion, Inc., 410 Sackett Point Road, North Haven, CT, 06473, US

(21) Appl. No.: 12/456,647

(22) Filed: Jun. 19, 2009

Related U.S. Application Data
(60) Provisional application No. 61/216,172, filed on May 14, 2009.

(51) Int. Cl. F02B 17/00; F01N 3/10; F02M 7/00

(52) U.S. Cl. 123/295; 60/299; 123/344

(57) ABSTRACT

A method is provided for achieving low NOx operation of homogeneous charge, lean burn reciprocating internal combustion engines. The method incorporates providing a fuel-air compression charge having a lean fuel-air ratio of less than the lean flammable limit, compressing the fuel-air compression charge to raise the adiabatic flame temperature to a predetermined value above the lean flammable limit, and igniting the compressed charge for combustion. A non-platinum oxidation catalyst may be included to control carbon monoxide emissions in the exhaust.

### CROSS-REFERENCE

This application claims the benefit of U.S. Provisional Application No. 61/216,172 filed on May 14, 2009.

### BACKGROUND OF THE INVENTION

1. Field of the Invention

This invention relates to an improved method of operating homogeneous charge internal combustion engines. More specifically, this invention relates to a method and means for achieving low NOx operation of homogeneous charge, lean burn reciprocating internal combustion engines.

2. Brief Description of the Related Art

The homogeneous charge reciprocating internal combustion engine represents the present state of the art for gasoline-powered engines that generally comprises the mixing of fuel and air together and then vaporizing the mixture prior to combustion. In contrast, the operation of a diesel engine generally comprises depositing droplets of fuel in the air which combination is then combusted. The present invention provides an improved method of operating a homogeneous charge reciprocating engine and compares such improvement to the operation of a diesel engine.

Unthrottled, lean fuel-air ratio internal combustion engines, such as the diesel engine, can achieve a significantly higher thermal efficiency than the throttled stoichiometric combustion engines used in most automobiles. In diesel engines, power is determined by the amount of fuel injected into compressed air. Thus, combustion in a diesel engine is essentially stoichiometric at the fuel droplet-air interface resulting in high local temperatures in the surrounding air and soot by pyrolysis of fuel in the fuel droplet. The result is high emissions of NOx and soot.

In Otto cycle engines, lean homogeneous combustion imposes flame stability limitations which to date have limited the capability to achieve lean enough operation for acceptable NOx levels, particularly at high engine speeds. Thus, to allow NOx control, conventional spark-ignited Otto cycle engines operate with stoichiometric fuel-air ratios with air flow throttled to adjust power level. Three-way exhaust catalysts allow low emissions of NOx, hydrocarbons and carbon monoxide. One problem associated with this prior art is that the use of platinum containing catalysts permits the emission of platinum oxides into the air. Throttling, together with insufficient oxygen for complete combustion, will result in a lower efficiency than a diesel engine.

In addition, conventional spark-ignited Otto cycle engines are less efficient than diesel engines in spite of operating in close approximation to the more efficient constant volume combustion Otto cycle. Thus, there is much effort to develop lean NOx control systems to allow use of lean-burn gasoline engines. However, throttling is still required.

It is therefore an object of the present invention to provide a method for the operation of an internal combustion engine/electric motor drive system whereby the internal combustion engine fuel-air ratio and the adiabatic flame temperature may be controlled to limit the formation of NOx and increase the efficiency of the overall system. It is another object of the present invention to provide a method and means for achieving low NOx operation of homogeneous charge, lean burn reciprocating internal combustion engines. It is yet another object of the present invention to provide a method for the unthrottled operation of a conventional spark-ignited Otto cycle engine sufficiently lean to achieve both low NOx and high efficiency.

### SUMMARY OF THE INVENTION

It has now been found that a homogeneous charge internal combustion engine, such as a reciprocating engine utilizing conventional gasoline fuel or any suitable substitute, may be operated sufficiently lean to achieve improved thermal efficiency and low pollutant emissions. NOx formation may be controlled by limiting the adiabatic flame temperature to a desired limit. Moreover, emission of platinum oxides from conventional clean-up catalysts may be controlled. With lean operation, emission of hydrocarbons and carbon monoxide is greatly reduced. Emissions may be further reduced by using an ultra low volatility non-platinum oxidation catalyst such as palladium, for example, to control carbon monoxide emissions in the exhaust.

By operation in an internal combustion engine/electric motor drive system, the internal combustion engine fuel-air ratio may be controlled such that the adiabatic flame temperature is above the lean flammable limit but below the temperature for the desired NOx formation value during combustion. NOx levels as low as 1 to 10 ppm are feasible.

### DETAILED DESCRIPTION OF THE INVENTION

One embodiment of the present invention comprising a homogeneous charge internal combustion engine comprises a reciprocating engine utilizing conventional gasoline fuel or any suitable substitute. The operation of such an engine does not cause similar soot problems associated with the operation of diesel engines. Without throttling, charge inlet losses can approximate those of a diesel engine and even higher fuel economy may be achieved.

In an internal combustion engine/electric motor drive hybrid system, the engine need be operated only with on and off operation, even unthrottled or at wide open throttle. Power may be varied by adjusting the fuel-air ratio or by controlling engine speed, such as with a continuously variable transmission and by varying the applied engine load as desired.

The lean fuel-air ratio mixture defines an adiabatic flame temperature and is passed into the engine. Such mixture passing into the engine, and typically subsequently into a cylinder, defines a fuel-air compression charge in the engine or cylinder. The lean fuel-air ratio, at the initial fuel-air compression charge within the engine, preferably should be less than the lean flammable limit for the lean fuel-air ratio mixture passed into the engine. Compressing the fuel-air compression charge to raise the adiabatic flame temperature to a predetermined value above the lean flammable limit provides the mechanism for controlling NOx emissions. On compression in the engine, the fuel-air mixture defines a compressed charge that defines a selected adiabatic flame temperature, preferably in the range of 2500° F. to 3000° F., which corresponds with a desired NOx emission control level. Higher flame temperatures provide for greater efficiency.

In a preferred embodiment of the present invention, the compression ratio is typically at least ten; that is, the compression charge is compressed at least by ten. Higher compression ratios are feasible and may be as high as fifteen or more. The compressed charge is subsequently ignited for combustion within the internal combustion engine. Typically, a spark is provided to initiate ignition of the compressed charge. Many methods are known in the prior art for providing such a spark; most notably, a spark plug.

Spark timing just before, or slightly after, top dead center provides for starting combustion at a higher flame temperature than the flame temperature for complete combustion. However, expansion lowers the temperature before peak combustion is reached. Spark timing no sooner than top dead center provides for more stable performance. Hybrid operation allows control of engine speed while providing for optimum combustion. Engine speed is limited by the time for combustion which is dependent upon the type of fuel used.

Although the invention has been described in considerable detail with respect to the operation of an internal combustion engine/electric motor drive system whereby the internal combustion engine fuel-air ratio and the adiabatic flame temperature may be controlled to limit the formation of NOx and increase the efficiency of the overall system, it will be apparent that the invention is capable of numerous modifications and variations, apparent to those skilled in the art, without departing from the spirit and scope of the invention.

1. A method of operating a lean-burn homogeneous charge reciprocating internal combustion engine comprising:
a) providing a fuel-air compression charge having a lean fuel-air ratio of less than the lean flammable limit;
b) compressing the fuel-air compression charge to raise the adiabatic flame temperature to a predetermined value above the lean flammable limit; and
c) igniting the compressed charge for combustion.

2. The method of claim 1 comprising providing a non-platinum oxidation catalyst to control carbon monoxide emissions in the exhaust.

3. The method of claim 1 wherein the engine is operated at wide open throttle.

4. The method of claim 3 wherein power is varied by adjusting the charged gas fuel-air ratio.

5. The method of claim 1 wherein the compressed charge adiabatic flame temperature is less than about 3000° F.

6. The method of operating an unthrottled, lean burn homogeneous charge reciprocating internal combustion engine comprising:
a) supplying a lean fuel-air ratio mixture having an adiabatic flame temperature such that on compression in the engine the adiabatic flame temperature is above the lean flammable limit;
b) compressing the mixture in the engine; and
c) igniting the compressed mixture for combustion.

7. The method of claim 6 wherein combustion is ignited at a point prior to top dead center.

8. The method of claim 6 wherein combustion is ignited no sooner than top dead center.

9. The method of claim 6 wherein engine speed is controlled by varying the applied engine load.

10. The method of claim 6 wherein power is controlled by varying the fuel-air ratio of the fuel-air mixture.

11. The method of claim 6 further comprising an internal combustion engine/electric motor drive hybrid system.

12. The method of claim 11 wherein the step of compressing the mixture further comprises compressing the mixture at least ten fold.

13. The method of claim 11 wherein the system is operated with on-off operation of the engine.
